(19) United States
(12) Patent Application Publication
(10) Pub. No.: US 2007/0200871 A1
(43) Pub. Date: Aug. 30, 2007

(54) Interface for enhanced movement of objects in a display

(75) Inventor: Yee Shian Lee, Singapore (SG)

Correspondence Address: CREATIVE LABS, INC.;LEGAL DEPARTMENT, 1901 MCCARTHY BLVD, MILPITAS, CA, 95035, US

(73) Assignee: Creative Technology Ltd

(21) Appl. No.: 11/641,452

(22) Filed: Dec. 18, 2006

(30) Foreign Application Priority Data
Dec. 21, 2005 (SG) SG200508284-7

(51) Int. Cl. G09G 5/00

(52) U.S. Cl. 345/619

(57) ABSTRACT

There is described a method for moving at least one object in a vertical plane in a display using an input device having a housing and a member that is rotatable relative to the housing. The method may comprise: selecting at least one object to be moved; rotating the member to move at least one object in a vertical plane; and determining enablement of an elevation control mode for the input device. The at least one object may move vertically when the elevation control mode is enabled. A corresponding graphical user interface facilitating the aforementioned method is also described.

### RELATED APPLICATION DATA

This application claims the benefit of Singapore Patent Application no. SG 200508284-7 filed on Dec. 21, 2005.

### FIELD OF INVENTION

This invention relates to an interface for enhanced movement of objects in a display, specifically pertaining to a method for moving at least one object in a vertical plane in a display using an input device and a corresponding graphical user interface.

### BACKGROUND

Scroll wheels are commonly integrated in computer mice and are used by users to scroll an image relative to a display screen of a host computer. Computer mice made by major peripheral manufacturers like Creative Technology, Microsoft, Logitech and Belkin among others all have such scroll wheels, making it a standard feature in most mice nowadays.

During the use of the scroll wheel in the mouse, the scroll wheel is typically rotated about a first, transversely extending axis secured within a housing in order to scroll an image up and down (vertically) relative to the display screen. This occurs because the rotation of the scroll wheel causes an encoder to sense the rotation of the scroll wheel that sends a corresponding signal to a host computer to move the image. The image being scrolled may be different types of documents, such as spreadsheets and reports, or online webpages.

The scroll wheel has been used to manipulate an environment like an image in an image viewer, whereby concurrent pressing of either the “shift” or “ctrl” keys together with rotation of the scroll wheel is required to pan or zoom the image. Currently, the scroll wheel in a mouse is not able to be used for moving designated objects in a vertical plane, be it icons, vertice points or cursors in a display screen.

When the user needs to move the objects vertically, the user must typically perform a number of tedious and potentially frustrating steps. These steps include locating a vertical scroll bar in a graphical user interface, positioning a cursor on the scroll bar, and then toggling the scroll bar. Locating the scroll bar may be inconvenient, and counter-intuitive. Alternatively, a different plane view such as the side view is provided, such that the user has to alternate between the side and top-down views to move an object in three dimensional space. Under these circumstances, time is wasted and task efficiency inevitably suffers.

### SUMMARY

There is provided a method for moving at least one object in a vertical plane in a display using an input device having a housing and a member that is rotatable relative to the housing. The method comprises selecting at least one object to be moved; rotating the member to move at least one object in a vertical plane; and determining enablement of an elevation control mode for the input device. Preferably, the at least one object moves vertically when the elevation control mode is enabled. The at least one object may preferably be used to denote a source of audio signals at a specific location and may be denoted by an icon. The object may also be a cursor depending on the application. The elevation control mode may be enabled from a list of preferences for the input device. There is also disclosed a computer usable medium comprising a computer program code that is configured to cause a processor to execute one or more functions to perform the aforementioned method.

The display may be either two dimensional or three dimensional. Preferably, the display is a screen of an electronic device. Preferably, the housing is for a device such as, for example, a mouse, a MIDI keyboard, an alphanumeric keyboard or a combination of the aforementioned. Advantageously, the member is depressible relative to the housing as depressing the member and subsequently rotating the member may activate a vertical movement of at least one object by a predetermined amount that may be defined from a list of preferences for the input device.

It is preferable that the movement of at least one object casts a shadow image on a reference horizontal plane in the display. This is because a vertical height of at least one object may be inferred from the shadow image on the reference horizontal plane in the display. It is advantageous that the movement of at least one object alters the visible size of the object as a vertical height of at least one object may be inferred from the visible size of the object.

In addition, there is provided a graphical user interface for moving at least one object in a vertical plane in a display using an input device having a housing and a member that is rotatable relative to the housing, with at least one object being moved by: selecting at least one object to be moved; rotating the member to move at least one object in a vertical plane; and determining enablement of an elevation control mode for the input device. Advantageously, the at least one object may move vertically when the elevation control mode is enabled. The display is may be two dimensional or three dimensional. It is preferred that the display is a screen of an electronic device. At least one object may be used to denote a source of audio signals at a specific location and the object may be represented as an icon. The object may also be a cursor depending on the application. The graphic user interface may include at least one user input field to control the position of at least one object, such as, for example, angle, distance or elevation.

There is also provided a computer usable medium comprising a computer program code that is configured to cause a processor to execute one or more functions to generate on a display the aforementioned graphical user interface, and to execute one or more functions of the graphical user interface.

### DESCRIPTION OF DRAWINGS

In order that the present invention may be fully understood and readily put into practical effect, there shall now be described by way of non-limitative example only preferred embodiments of the present invention, the description being with reference to the accompanying illustrative drawings.

FIG. 1 shows a computer mouse used in a preferred embodiment of the present invention.

FIG. 2 shows an alphanumeric keyboard usable in a preferred embodiment of the present invention.

FIG. 3 shows a setup employed in a preferred embodiment of the present invention.

FIG. 4 shows a flow chart denoting a preferred embodiment of the present invention.

FIG. 5 shows a user preference menu utilised in a preferred embodiment of the present invention.

FIG. 6 shows a graphical user interface utilised in a preferred embodiment of the present invention.

### DESCRIPTION OF PREFERRED EMBODIMENTS

The following discussion is intended to provide a brief, general description of a suitable computing environment in which the present invention may be implemented. Although not required, the invention will be described in the general context of computer-executable instructions, such as program modules, being executed by a personal computer. Generally, program modules include routines, programs, characters, components, data structures, that perform particular tasks or implement particular abstract data types. As those skilled in the art will appreciate, the invention may be practiced with other computer system configurations, including hand-held devices, multiprocessor systems, microprocessor-based or programmable consumer electronics, network PCs, minicomputers, mainframe computers, and the like. The invention may also be practiced in distributed computing environments where tasks are performed by remote processing devices that are linked through a communications network. In a distributed computing environment, program modules may be located in both local and remote memory storage devices.

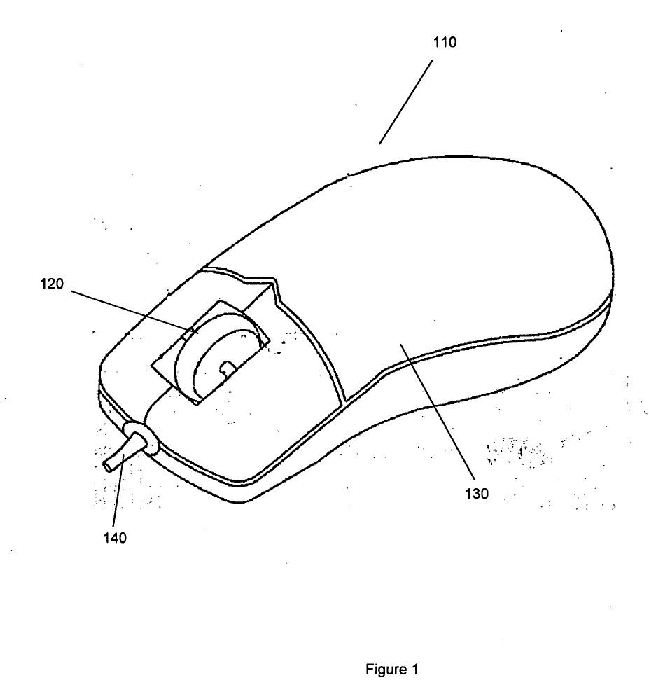

Referring to FIG. 1, there is shown a computer mouse 110 that may be employed in a preferred embodiment of the present invention. The mouse 110 may have a scroll wheel 120 that is rotatable relative to a housing 130. While the mouse 110 as illustrated is wired 140 for connection to a computer, the mouse 110 may also be connected wirelessly using wireless technologies such as, for example, UWB, Bluetooth, infrared, or any form of radio frequency transmission. The mouse 110 is basically an input device for the computer. The scroll wheel 120 may rotate in steps and not smoothly to provide better control of wheel 120 rotation.

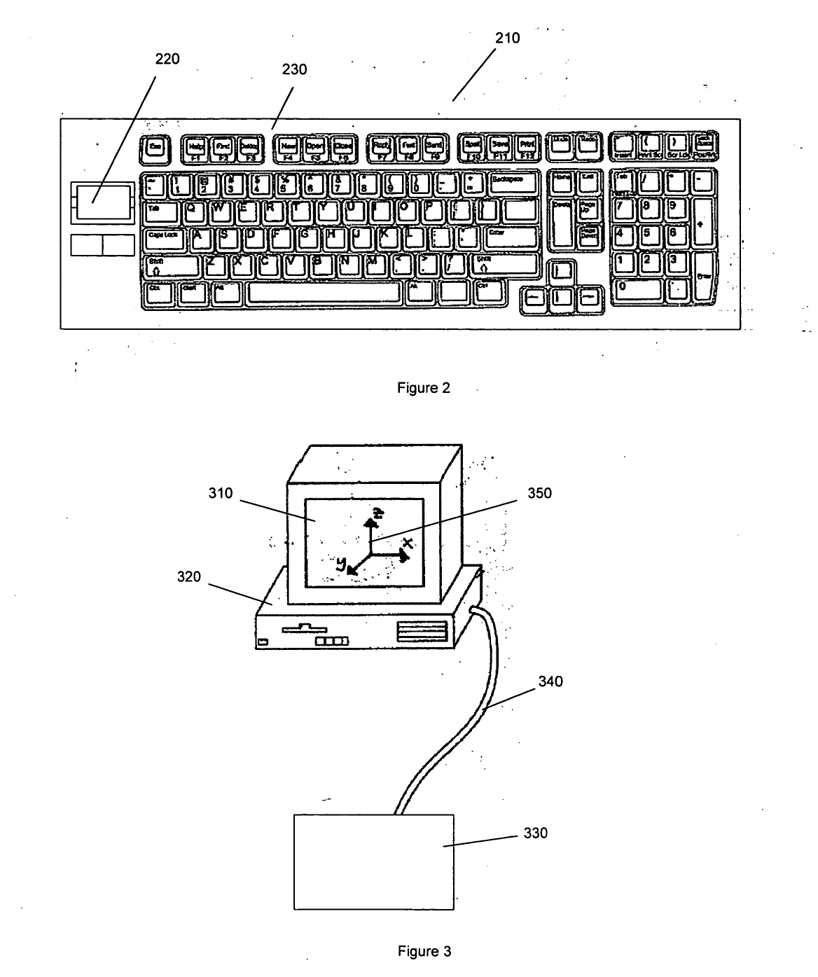

Referring now to FIG. 2, there is shown an alphanumeric keyboard 210 with a scroll wheel 220 that may also be employable in a preferred embodiment of the present invention. The scroll wheel 220 is rotatable relative to housing 230. The keyboard 210 may be connected to a computer via a wire or wirelessly using wireless technologies such as, for example, UWB, Bluetooth, infrared, or any form of radio frequency transmission. The keyboard 210 is also an input device for the computer. The scroll wheel 220 may also rotate in steps and not smoothly to provide better control of wheel 220 rotation.

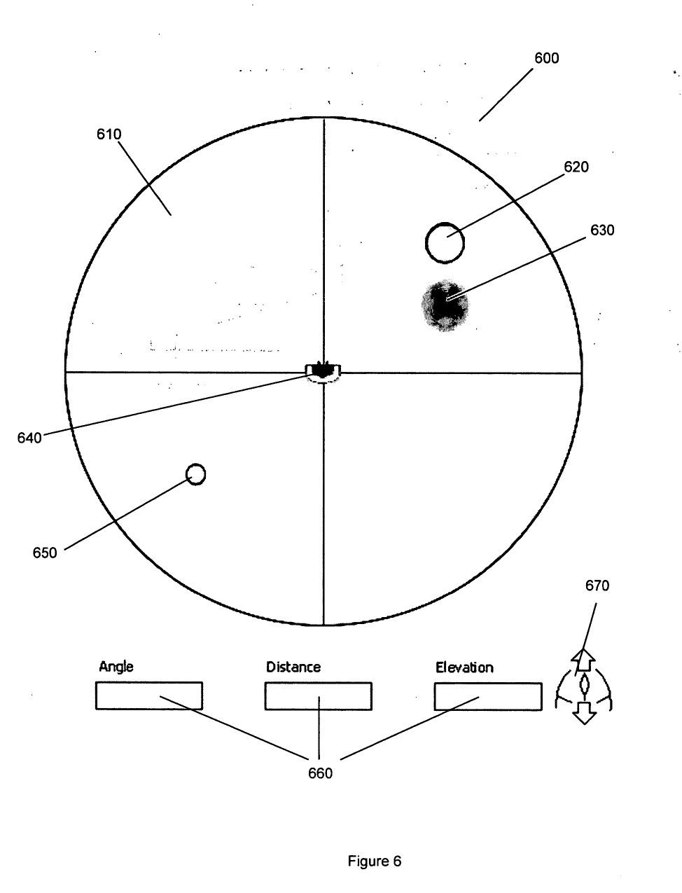

FIG. 3 shows a typical setup used in a preferred embodiment of the present invention. The typical setup can be broken down to a display screen 310, a central processing unit (CPU) 320, and at least one input device 330. The input device 330 may be at least one of the aforementioned input devices or any other input device like a MIDI keyboard with a scroll wheel or scroll wheel functionality. As mentioned earlier, while the connection of the input device 330 is shown to be wired 340, each input device 330 may also be connected wirelessly using wireless technologies such as, for example, UWB, Bluetooth, infrared, or any form of radio frequency transmission. While the setup shown is that of a desktop computer system, the typical setup also includes portable computer systems like notebook computers and personal digital assistants (PDAs) among others. The display screen 310 of FIG. 3 shows a three dimensional axis system 350 for applications that require manipulation in a three dimensional environment. Some of these applications may be computer aided design (CAD) like Autocad by Autodesk Inc, or spatial audio editing software like 3D MIDI Player/Audio Creation Mode Console by Creative Technology Ltd. In the spatial audio editing software, the object being moved may be a source of audio signals. This will be further described in FIG. 6.

It should be noted that when vertical plane/axis is mentioned in this document, the axis in question relates to the z-axis as denoted in the three dimensional axis system 350. It should also be noted that manipulation in a three dimensional environment may also be possible with a two dimensional display with appropriate simulated lighting effects such as shadowing and varying the visible size of an object when moved in the vertical plane. This is shown in FIG. 6 whereby the positions of the y and z axes are swapped. A more detailed description of FIG. 6 will be provided in a later portion.

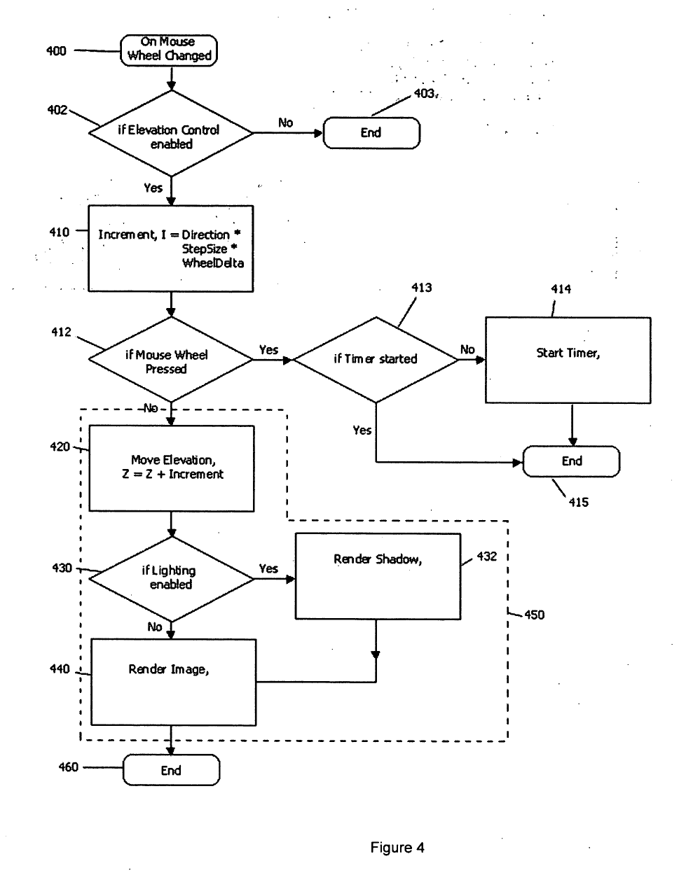

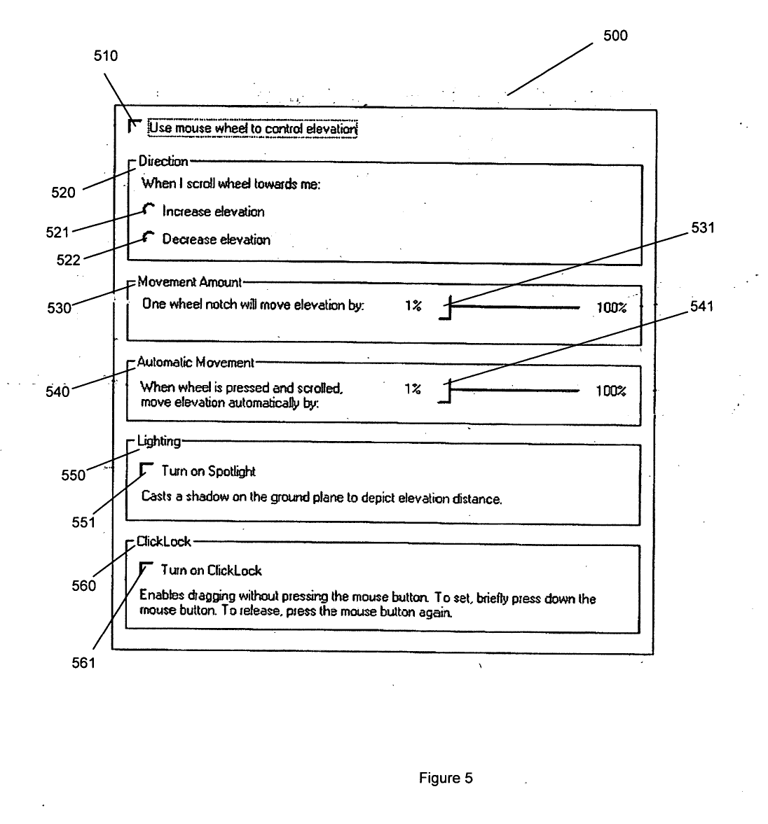

FIG. 4 shows a flow chart of a preferred embodiment of the present invention when employed in a computer application that requires manipulation in a three dimensional environment. There is shown a method for moving at least one object in a vertical plane in a display of an electronic device using an input device like those shown in FIGS. 1 and 2, having a housing and a member that is rotatable relative to the housing. The input device may also be a MIDI keyboard or a combination of the aforementioned input devices. The method comprises selecting at least one object to be moved, where the object may be an icon or a cursor. Firstly, the rotating member (mouse wheel) is rotated 400. A processor in the electronic device then determines whether elevation control is enabled 402. Elevation control may be enabled from a user preferences menu 500 that is shown, for illustration purposes, in FIG. 5. Further explanation of the menu 500 will be provided in a later section, but at this juncture, it should be noted that elevation control is enabled by clicking on a topmost selection box 510.

If elevation control has not been enabled, the at least one object that has been selected does not move when the rotating member is rotated 403.

If elevation control has been enabled, the processor then carries out instructions to move the selected object vertically 410 in the display. The increment (I), that the object moves is determined by:
I=Direction×Stepsize×Wheeldelta
where: Direction is the-direction that the scroll wheel is rotated (defined in user preferences menu 500, box 520 that is shown, for illustration purposes, in FIG. 5);
   Stepsize is the object movement per notch of the scroll wheel (defined in user preferences menu 500 as “Movement Amount” 530); and
   Wheeldelta is the number of notches the scroll wheel moves.

Depressing the member relative to the housing 412 and subsequently rotating the member may automatically move the selected object to a desired position within a predetermined timer duration 415 from the time the timer starts 413. The incremental movement of the object is defined in the user preferences menu 500 (in “Automatic Movement” box 540) that is shown in FIG. 5. If the processor checks that the timer has not started, the processor starts the timer 414 and lets the timer run for the predetermined timer duration during which the object moves by the pre-defined increment amount in the vertical axis. Activating automatic movement avoids the instance of erratic movement of the object. In the instance of audio recording software, this improves the quality and consistency of the sound recording.

Automatic movement of the selected object is not activated if the member is not depressed. The process of moving the selected object then begins 450. The selected object may move vertically by an increment of I (may be positive or negative depending on the direction the member is rotated) 420, that is:
Z_{final}=Zᵢₙᵢₜᵢₐₗ+I
where: Z_{final} is the final Z ordinate of the object; and Zᵢₙᵢₜᵢₐₗ is the initial Z ordinate of the object.

The processor then determines whether a lighting feature is enabled 430 in a “Lighting” box 550 of the user preferences menu 500. If the lighting feature is enabled by clicking on sub-box 551, an image of a shadow is rendered on a reference horizontal plane in the display. The visible size of the object, and the size and lightness of the image of a shadow may all be directly proportional to Z_{final} (or F(Z_{final})) 432. A user may be able to infer the height of the object either by looking at the visible size of the object (especially in a two dimensional environment as shown in FIG. 6) or by looking at the image of the shadow rendered on the reference horizontal plane in the display. An object will look bigger if it is at a distance (rather than close to) from the reference horizontal plane as it is closer to the user viewing the display. Similarly, an object will “cast” an image of a shadow when it is at a distance from the reference horizontal plane. An object at a distance from the reference horizontal plane “casts” a lighter shadow compared to an object closer to the reference horizontal plane.

If the lighting feature has not been enabled, no image of a shadow will be rendered on the reference horizontal plane. However, the size of the object still varies depending on the vertical height of the object above the reference horizontal plane. The object will simply move and be displayed at the desired position 440. The process of moving the object is then concluded 460.

Alternatively, if neither the lighting feature nor the object size variation feature is activated/present, a height or a set of Cartesian coordinates of the object may be included within parentheses and indicated next to the object to denote its position.

Referring to FIG. 5, there is shown the user preferences menu 500 as mentioned in earlier portions of this section. The menu 500 may be included with the input device application software or software such as computer aided design (CAD) like Autocad by Autodesk Inc, or spatial audio editing like 3D MIDI Player/Audio Creation Mode Console by Creative Technology Ltd. It should be noted that menu 500 as shown in FIG. 5 is for illustration purposes. The actual menu 500 used may include more or fewer selections. The menu 500 may also be in the form of a toolbar that may be called up by the user in any software environment that may require vertical movement of objects.

As mentioned earlier, clicking on the topmost selection box 510 enables the use of the mouse wheel to control elevation. The other options in menu 500 may not be accessed if the selection box 510 is not clicked upon.

There is a “Direction” box 520 where the user is able to define whether the selected object increases 521 or decreases 522 elevation when the rotating member is scrolled towards the user. This is necessary as some users are more attuned to “aeroplane pilot” convention where scrolling the rotating member backwards (scroll towards user) means to elevate and scrolling the rotating member forwards (scroll away from user) means to descend. Other users adhere to normal convention where forward scrolling means to elevate and backward scrolling means to descend.

Both “Movement Amount” 530 and “Automatic Movement” 540 boxes essentially determine the rate the object moves in relation to movement of the rotating member. The closer the selector tabs 531, 541 are slid to 100%, the less sensitive the object is to movements of the rotating member. The “Movement Amount” box 530 specifically determines the rate of movement of the object when the rotating member is scrolled but not depressed, while the “Automatic Movement” box 540 specifically determines the automatic rate of movement of the object when the rotating member is depressed and subsequently scrolled. Tuner knobs may also be used in place of the slider bars.

A “Lighting” box 550 allows for the “switching on” of a spotlight so that images of shadows of the object are cast on the reference horizontal plane to depict elevation distance. This will be more thoroughly explained and illustrated with reference to FIG. 6 in a later portion. The spotlight is “switched on” simply by clicking on sub-box 551.

Finally, a “Clicklock” box 560 that is shown in FIG. 5 relates to movement of the object along/parallel to the reference horizontal plane. Although it does not relate to the movement of the object vertically, a description will still be provided for the sake of completeness. Clicking on sub-box 561 enables “clicklock”, which allows for the dragging of the object along the reference horizontal plane without continually depressing a left mouse button as per standard convention and practice. However, the object to be moved should still be clicked on (selected) prior to moving the object, and the left mouse button should be clicked on again after the object is at a desired position to release the mouse from its task of moving the object.

Referring to FIG. 6, there is shown a graphical user interface 600 for moving at least one object in a vertical plane in a display using an input device having a housing and a member that is rotatable relative to the housing. The graphic user interface 600 may be useful to determine optimum locations for the at least one object in an audio application. In this instance, the object 620 represents an audio source. While the object 620 is represented by a circle, it can be of any shape or appearance. The object 620 may represent a position of at least one speaker or it may denote a position where sounds seem to be emanating from. The circular region 610 shows a representative area where the objects may be located. The region 610 may be triangular, quadrilateral, polygonal or any other shape. The view of the region 610 shown in FIG. 6 is a plan or top view (two dimensional), but it should be noted that the region 610 may also be presented in an isometric view (three dimensional). It should be noted that the display is a screen of an electronic device.

A first object 620 is shown. A shadowy image 630 in the circular region 610 is also shown. The image 630 represents the shadow of the object 620 cast on the region 610 when a light is “shining” from vertically above an in-display representation of the user 640. The appearance of the image 630 aids the user in appreciating that the object 620 is elevated above the region 610. It should be noted that the image 630 only appears when sub-box 551 of the “Lighting” box 550 of the user preferences menu 500 is clicked upon. The in-display representation of the user 640 may also represent the direction and position of the user. While the in-display representation of the user 640 locates the user at the centre of the region 610, the location of the user may be variable. There may also be more than one user included in the region 610.

A second object 650 is shown to depict the appearance of an object on the surface of region 610. There is no shadowy image accompanying the second object 650 and the size of the second object 650 is conspicuously smaller than that of the first object 620. This is so as the first object 620 is at a position “closer” to a user looking at the display compared to the second object 650.

It should be noted that the first 620 and second 650 objects may be moved vertically using the rotating members 120, 220 of the input devices 110, 210. Other input device may include MIDI keyboards or combination devices with similar rotating members. Alternatively, discrete positional data may be entered to a plurality of input fields 660 in order to re-position an object. For illustration purposes, the input fields 660 shown are angle, distance and elevation. All the input fields are required to be filled for every instance. For example, inputting two values of a distance (from the user in the centre of region 610), and an angle would be adequate to determine the final location of the object using trigonometry in a horizontal plane. This is further demonstrated below: [image]
sin(angle)=y/distance or cos(angle)=x/distance

The elevation is then entered for the height of the object in the vertical plane.

Alternative discrete positional data that may be entered to locate an object may be the x, y and z coordinates of the object.

Alternatively, the values for the input fields may be entered using slider bars or tuner knobs. Finally, clicking the mouse icon 670 at the bottom right corner of the interface 600 may call up the user preferences menu 500 of FIG. 5 where user preferences may be enabled/disabled. The user preferences menu 500 may also be accessed by clicking on a “settings” logo/tab (not shown). The mouse icon 670 may also act as a visual representation of how a user may use the scroll wheel to control elevation.

It should be noted that the interface 600 may have more or less features than that as shown.

There is also provided a computer usable medium comprising a computer program code that is configured to cause a processor to execute one or more functions to generate on a display the graphic user interface 600. The processor may be able to execute one or more functions of the graphic user interface 600.

Whilst there has been described in the foregoing description preferred embodiments of the present invention, it will be understood by those skilled in the technology concerned that many variations or modifications in details of design or construction may be made without departing from the present invention.

1. A method for moving at least one object in a vertical plane in a display using an input device having a housing and a member that is rotatable relative to the housing, the method comprising:
selecting at least one object to be moved;
rotating the member to move at least one object in a vertical plane; and
determining enablement of an elevation control mode for the input device,
wherein the at least one object moves vertically when the elevation control mode is enabled.

2. The method as claimed in claim 1, wherein the display is selected from the group comprising: two dimensional and three dimensional.

3. The method as claimed in claim 1, wherein the display is a screen of an electronic device.

4. The method as claimed in claim 1, wherein at least one object is used to denote a source of audio signals at a specific location.

5. The method as claimed in claim 1, wherein at least one objected is selected from a group comprising: an icon, a vertice point and a cursor.

6. The method as claimed in claim 1, wherein the housing is for a device selected from the group comprising: a mouse, a MIDI keyboard, an alphanumeric keyboard and a combination of the aforementioned.

7. The method as claimed in claim 1, wherein the elevation control mode is enabled from a list of preferences for the input device.

8. The method as claimed in claim 1, wherein the member is depressible relative to the housing.

9. The method as claimed in claim 8, wherein depressing the member and subsequently rotating the member activates a vertical movement of at least one object by a predetermined amount.

10. The method as claimed in claim 9, wherein the predetermined amount is defined from a list of preferences for the input device.

11. The method as claimed in claim 1, wherein the movement of at least one object casts a shadow image on a reference horizontal plane in the display.

12. The method as claimed in claim 11, wherein a vertical height of at least one object can be inferred from the shadow image on the reference horizontal plane in the display.

13. The method as claimed in claim 1, wherein the movement of at least one object alters the visible size of the object.

14. The method as claimed in claim 13, wherein a vertical height of at least one object can be inferred from the visible size of the object.

15. A computer usable medium comprising a computer program code that is configured to cause a processor to execute one or more functions to perform the method of claim 1.

16. A graphical user interface for moving at least one object in a vertical plane in a display using an input device having a housing and a member that is rotatable relative to the housing, with at least one object being moved by:
selecting at least one object to be moved;
rotating the member to move at least one object in a vertical plane; and
determining enablement of an elevation control mode for the input device,
wherein the at least one object moves vertically when the elevation control mode is enabled.

17. The graphical user interface as claimed in claim 16, wherein the display is selected from the group comprising: two dimensional and three dimensional.

18. The graphical user interface as claimed in claim 16, wherein the display is a screen of an electronic device.

19. The graphical user interface as claimed in claim 16, wherein at least one object is used to denote a source of audio signals at a specific location.

20. The graphical user interface as claimed in claim 16, wherein at least one object is selected from the group comprising: an icon, a vertice point and a cursor.

21. The graphical user interface as claimed in claim 16, wherein the housing is for a device selected from the group comprising: a mouse, a MIDI keyboard, an alphanumeric keyboard and a combination of the aforementioned.

22. The graphical user interface as claimed in claim 16, wherein the elevation control mode is enabled from a list of preferences for the input device.

23. The graphical user interface as claimed in claim 16, wherein the member is depressible relative to the housing.

24. The graphical user interface as claimed in claim 23, wherein depressing the member and subsequently rotating the member activates a vertical movement of at least one object by a predetermined amount.

25. The graphical user interface as claimed in claim 24, wherein the predetermined amount is defined from a list of preferences for the input device.

26. The graphical user interface as claimed in claim 16, wherein the movement of at least one object casts a shadow image on a reference horizontal plane in the display.

27. The graphical user interface as claimed in claim 26, wherein a vertical height of at least one object can be inferred from the shadow image cast on the reference horizontal plane in the display.

28. The graphical user interface as claimed in claim 16, wherein the movement of at least one object alters the visible size of the object.

29. The graphical user interface as claimed in claim 28, wherein a vertical height of at least one object can be inferred from the visible size of the object.

30. The graphical user interface as claimed in claim 16, further including at least one user input field to control the position of at least one object, selected from the group comprising: angle, distance and elevation.

31. A computer usable medium comprising a computer program code that is configured to cause a processor to execute one or more functions to generate on a display the graphical user interface of claim 16.

32. The computer usable medium as claimed in claim 31, wherein the processor is able to execute one or more functions of the graphical user interface.
